(19) United States
(12) Patent Application Publication
(10) Pub. No.: US 2006/0068351 A1
(43) Pub. Date: Mar. 30, 2006

(54) Apparatus and method for providing a prescription orthodontic bracket kit

(76) Inventor: Daniel Castner, San Marcos, CA (US)

Correspondence Address: FULWIDER PATTON, 6060 CENTER DRIVE, 10TH FLOOR, LOS ANGELES, CA, 90045, US

(21) Appl. No.: 10/939,129

(22) Filed: Sep. 10, 2004

(51) Int. Cl. A61C 3/00; B65D 83/10

(52) U.S. Cl. 433/2; 206/369

(57) ABSTRACT

A prescription kit of orthodontic brackets is provided for orthodontists on an individual patient or pre determined basis. The orthodontist does not have to carry a large inventory of orthodontic brackets, rather the orthodontist places a prescription order with the orthodontic manufacturer for an individual patient's prescription needs for a seven to thirty day or longer time frame. The orthodontic bracket manufacturer fills the prescription, preferably within twenty-four hours, and sends back the individual patient's prescription order of orthodontic brackets to the orthodontist. The orthodontic brackets are assembled on a bonding card so that the brackets may be easily removed and mounted on the patient's teeth.

### BACKGROUND OF THE INVENTION

During the course of an orthodontic treatment, small brackets are attached to a patient's teeth and then an archwire is removably attached to the brackets. Due to the bending forces imparted by the archwire, the teeth will move according to a prescription determined by the orthodontist.

Prior to mounting the brackets on the patient's teeth, the orthodontist typically will take mold impressions of the patient's teeth and create a mold to assist the orthodontist in treatment planning and determining a prescription of brackets and arch wires to use on a particular patient. For each patient, each tooth will have a different angulation, torque and other geometric requirements for brackets used in treatment. In some cases orthodontists may use the same bracket angulations, torques and geometries on multiple teeth, however, often the orthodontist at the beginning of the procedure plans on using specific bracket angulations, torques and geometries in order to move the tooth to the proper orientation at the completion of the procedure. Thus, the orthodontist must keep a large inventory of different types of brackets, including those with different angulations, torques and geometries to treat a wide variety of patients and conditions.

In a typical orthodontic practice, brackets are ordered from the manufacturers involved usually to fill patient demands for at least thirty days, and in some instances, in order to obtain a better price for volume purchases, an orthodontist may place an order for a supply of brackets that will last for six months to one year. Further, the orthodontist wants to make sure that he/she does not experience an outage for critical parts, and accordingly may keep inventories at even higher levels.

In most orthodontic offices brackets are stored in plastic trays with “egg shell shaped” insets which hold multiple brackets for each tooth. In some cases the orthodontist stores brackets in the manufacturers original packages by individual teeth.

Some orthodontic bracket manufacturers ship brackets to the orthodontist in multipack configurations of fives, tens and twenties. The orthodontist is restricted from ordering single brackets. The orthodontist will then have to place these brackets in the plastic trays for storage for later use.

When the orthodontist receives brackets, they are routinely shipped in bulk from the manufacturer and someone in the orthodontist's office must separate the brackets and place them in a storage system where like brackets are stored together for later use. Once the orthodontist has determined a particular prescription for a patient, the brackets are selected from the inventory and typically placed on a bonding card with a sticky surface so that the brackets can be easily identified and removed for positioning on the patient's teeth. The bonding card is labeled to correspond to the patient's teeth. When all of the brackets are selected from inventory and placed on the bonding card, they are then ready to be removed from the bonding card and cemented on the patient's teeth.

In many cases brackets get mixed up in these storage containers and in other cases bracket storage boxes get knocked over and spilled. This results in an orthodontic office having to re-sort and place each bracket back into their designated “egg shell.” This results in lost brackets and brackets becoming disoriented and contaminated.

What has been needed, and heretofore unavailable, is a method for supplying brackets to the orthodontists to reduce the inventory selection process and the chance of mixing brackets. Further, what has been needed and heretofore unavailable is a bonding card that can be customized for each patient, thereby eliminating errors and the orthodontic office time in selecting orthodontic brackets from a large inventory and matching them to the patient's prescription needs. The present invention satisfies these unmet needs.

### SUMMARY OF THE INVENTION

The present invention relates generally to an apparatus and method for providing a prescription orthodontic bracket kit that eliminates the need for an orthodontist to carry a large inventory of orthodontic brackets, and eliminates the need for the orthodontist's office to select the patient prescription from a larger inventory.

The present invention allows the orthodontist to communicate with the bracket manufacture on a direct basis for each patient if desired. Once the orthodontist has determined the prescription needs for a particular patient, the prescription information is communicated to the orthodontic manufacturer, typically via facsimile, e-mail, website or by telephone. After receiving the patient prescription from the orthodontist, the orthodontic manufacturer selects the prescribed brackets from the orthodontic manufacturer's inventory of orthodontic brackets. The brackets are placed on a bonding card which has a sticky backing and are placed in the proper orientation in “tweezer ready” format that will allow the orthodontist to remove the brackets with tweezers that are typically used in the orthodontist's office. The bonding card is sealed and labeled by the orthodontic manufacturer, and then shipped to the orthodontist where the package can be stored until the patient is ready to receive the brackets.

In the event that the doctor prescribes that not all teeth will be bonded on the first bonding appointment, the bonding card can be re-sealed by the orthodontist and placed in storage with the patient's chart file. At a later appointment, the brackets that were not bonded during the first appointment will be ready to bond at a later appointment chosen by the orthodontist. If a bracket is not used in the treatment of a particular patient, the bracket(s) can then be stored in a smaller storage area for loose brackets and bracket to be used for re-bonds in the event a bracket comes off and is lost during treatment.

The present invention eliminates the need for the orthodontist to carry a large inventory of orthodontic brackets, select brackets from that inventory for a patient's prescription, and saves the cost of the bracket inventory and the time it takes staff members to organize brackets in the inventory, and to select brackets out of the inventory for a patient's prescription.

The bracket envelope has wells or troughs where bonding cements and sealants can be placed by the orthodontist and used to dispense cement from the wells onto the brackets before bonding to the teeth. The invention also provides for the orthodontic manufacturer to pre-load cement and seal the wells to protect the cement.

These and other advantages of the invention will become more apparent from the following detailed description of the invention, when taken in conjunction with the accompanying exemplary drawings.

### BRIEF DESCRIPTION OF THE DRAWINGS

FIG. 1 is a plan view depicting the front face of a three-sectioned orthodontic bracket bonding card.

FIG. 2 is a plan view of the back face of the bonding card of FIG. 1.

FIG. 3 is a side view of a portion of the bonding card of FIG. 1 depicting the orthodontic bracket receptacles.

FIG. 4 is a front edge view of a portion of the bonding card of FIG. 1 depicting the orthodontic receptacles.

FIG. 5 is a perspective view of a portion of the bonding card of FIG. 1 depicting multiple receptacles for retaining orthodontic brackets.

FIG. 6 is an exploded view of a portion of the bonding card of FIG. 1 depicting a polymer seal which overlies a portion of the bonding card that retains the orthodontic brackets.

FIG. 7A is a perspective view of the bonding card of FIG. 1 depicting the sections being folded onto each other.

FIG. 7B is a side view of another embodiment of the bonding card of FIG. 1 depicting the sections being folded onto each other.

FIG. 8 is a plan view of the bonding card displaying patient information.

FIG. 9 is a plan view of the bonding card of FIG. 1 depicting the sixth face and displaying the orthodontic brackets through either transparent receptacles or non-transparent (light blocking) material.

FIG. 10 is a perspective view of the bonding card of FIG. 9 depicting the transparent receptacles in an elevated condition and displaying the orthodontic brackets in proper position to place brackets on teeth.

FIG. 11 is a front plan view of a bonding card having two elongated sections or receptacles for orthodontic adhesive or cement.

FIG. 12 is a back plan view of the two-section bonding card of FIG. 11.

FIG. 13 is a perspective view of the two-section bonding card of FIG. 11 depicting the bonding card being folded to a closed position.

FIG. 14 is a plan view of one face of the bonding card of FIG. 11 in a closed configuration and depicting patient information and/ or prescription information.

FIG. 15 is a plan view of one face of the bonding card of FIG. 11 depicting the receptacles and orthodontic brackets for display.

FIG. 16 is a plan view depicting a single-section bonding card displaying the receptacles and containing the orthodontic brackets.

FIG. 17 is a plan view of the single-section bonding card of FIG. 16 depicting a face displaying the patient information.

FIG. 18 is a perspective view of the single-section bonding card of FIG. 16 depicting the receptacles containing the orthodontic brackets.

### DETAILED DESCRIPTION OF THE INVENTION

The present invention relates generally to an apparatus and method for providing a prescription or predetermined set of orthodontic brackets in a patient prescription kit which is determined by the doctor and which eliminates the need for an orthodontist to carry a large (or centralized) inventory of orthodontic brackets in his/her office. It further eliminates the need for the staff in the orthodontist's office to select orthodontic brackets from the individual bracket inventory in order to fill a particular patient's prescription needs. More particularly, the present invention relates to a method for ordering orthodontic brackets from the orthodontic bracket manufacturer.

After the orthodontist has determined a prescription for orthodontic brackets for a particular patient, the orthodontist will convey the prescription information directly to the orthodontic manufacturer either by facsimile, telephone, e-mail, website or other rapid communication means. Thereafter, the orthodontic bracket manufacturer fills the prescription for orthodontic brackets by selecting the brackets from the orthodontic manufacturer's inventory. The prescription of orthodontic brackets are placed on a bonding card which is then delivered to the orthodontist for storage until the brackets are to be placed on the patient's teeth.

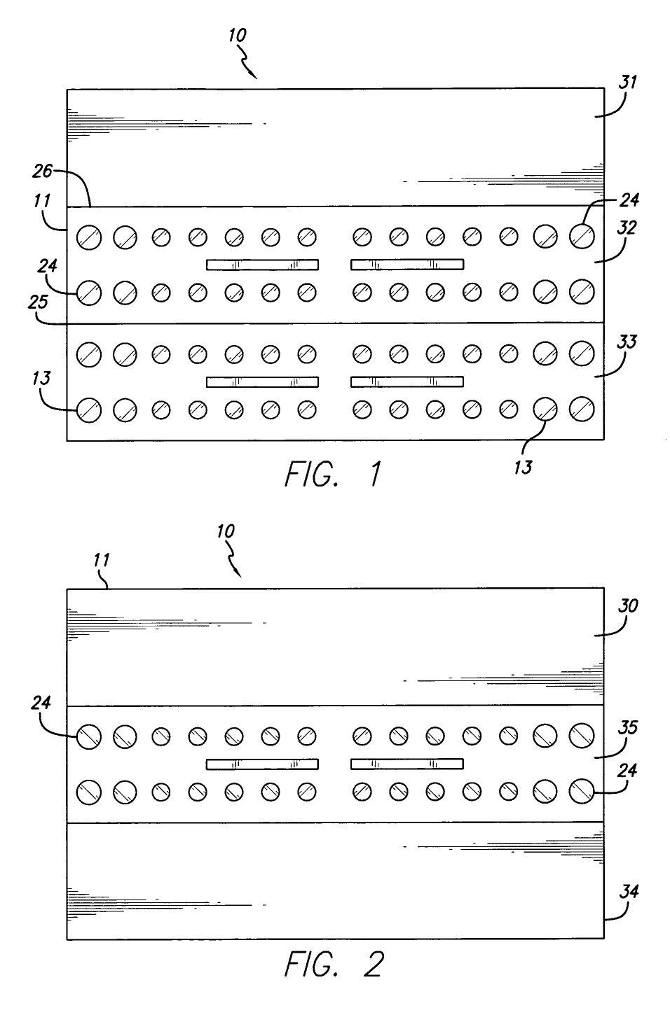

In keeping with the invention, and referring to FIGS. 1-10, a kit 10 is provided which includes a bonding card 11 which is designed to hold orthodontic brackets 12. As can be seen in the drawings, the bonding card has multiple tooth-position pads 13 which correspond to a full set of teeth. For example, the designation UR7 corresponds to an upper right molar and is the seventh tooth in the upper arch starting from the midline and going toward the right while facing the patient. For a typical patient, only the upper fourteen teeth and lower fourteen teeth in the upper arch and the lower arch are included in a standard prescription kit. However, if the patient has more than fourteen teeth in either the upper or lower arch, the kit can be modified to include tooth-position pads in the number eight position in either the upper arch or the lower arch. Each of the tooth-position pads has a pressure sensitive adhesive 14 that is designed to hold the corresponding orthodontic bracket relative to the tooth-position pad until the orthodontist is ready to remove the bracket for placement on the patient's teeth. The pressure sensitive adhesive typically is sticky enough to hold the bracket on the pad, yet the bracket is easily removed by tweezers typically used by the orthodontist in placing the brackets on the patient's teeth. The pressure sensitive material is designed to keep the bracket mesh pad clean of contaminant particles and keep the brackets in their correct tooth positions.

Examples of pressure sensitive adhesives include adhesives known by the trade names DUBLFILM® S305 and BIOFLEX® RX159-001 manufactured by Scapa North America. These adhesives typically come in a transfer tape form or an adhesive film and can be applied to the bonding card by applying the adhesive side of the tape to the bonding card mounting surface. Thereafter, a thin piece of cardboard or clear plastic liner (not shown) having the multiple tooth position pads 13 formed therein, can be applied over the adhesive and onto the bonding card in order to expose the pressure sensitive adhesive 14 the tooth position pads. The pressure sensitive adhesive should have specific product safety features including passage of state or federal regulations for skin irritation, cytoxicity, and indirect food contact. The adhesive should have a thickness of approximately 0.50 mils (0.013 mm) up to about 1.25 mils (0.033 mm). Further, these adhesives allow the orthodontic bracket to adhere to the pad, yet are easily removed by tweezers, and reapplied if necessary for later use. In other words, if the orthodontist removes a bracket and then determines that the bracket will not be placed on the patient's tooth during that office visit, the bracket can be placed back on the bonding pad and the adhesive will adhere and hold the bracket in place until a later office visit, at which time the bracket can be removed by tweezers as previously described. The DUBLFILM® S305 and the BIOFLEX® RX159-001 adhesives are acrylic pressure sensitive adhesives that have been approved for indirect food contact, and therefore are suitable for the present invention. Similarly, all biocompatible pressure sensitive adhesives, whether or not they are acrylic-based, are suitable for use with the present invention.

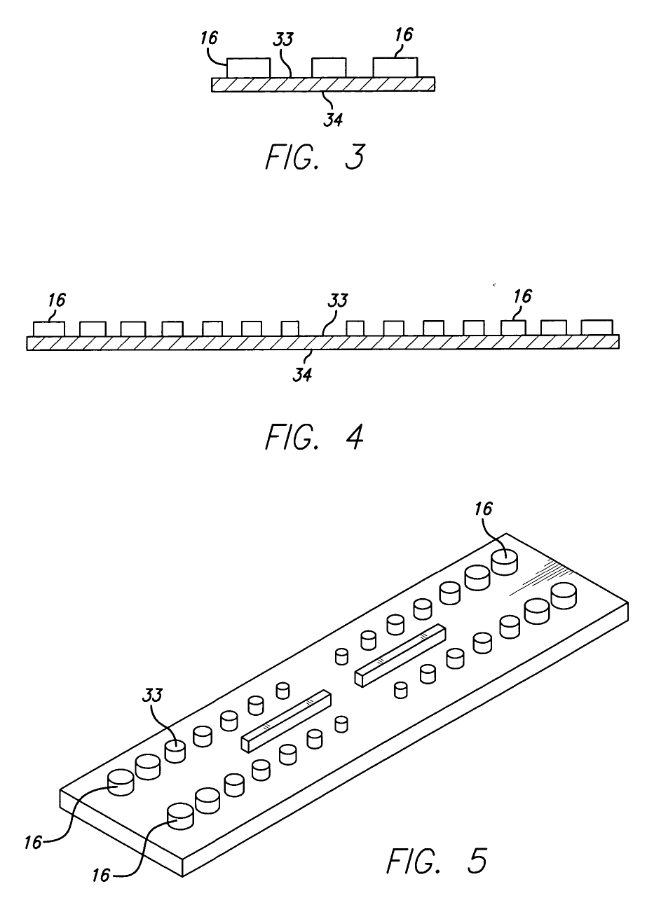

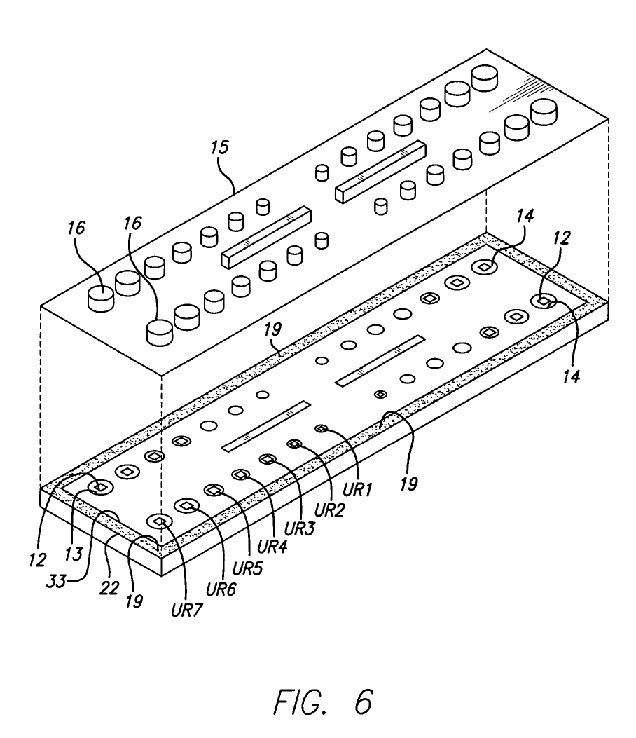

In order to protect the orthodontic brackets 12 from the time they leave the orthodontic bracket manufacturer until they arrive at the orthodontist's office, and are ready to be placed on the patient's teeth, a protective cover 15 is placed on the bonding card 11 and will overlay the orthodontic brackets. More particularly, the cover includes receptacles or wells 16 which are essentially bubbles that overly the orthodontic brackets placed on the tooth-position pads 13. Preferably, the cover and receptacles are made out of a transparent plastic or light protecting opaque plastic which generally has the shape of at least a portion of the bonding card 11. The plastic material also can be formed of light protected version to keep any light sensitive adhesive from being prematurely polymerized before bonding the brackets to teeth. The receptacles may vary in size and shape in order to accommodate the different sizes of orthodontic brackets. For example, as shown in FIGS. 3-7, the receptacles can have a round or tubular appearance, and are elevated from the position pads in order to create a space for the orthodontic bracket. The receptacles act as a housing to cover the brackets, and depending upon the need, may be sealed 19 in order to create a sterile environment for the orthodontic bracket. In some instances, the receptacles may be formed from a heat-shrinkable plastic so that the receptacle essentially collapses onto the orthodontic bracket to secure and retain the bracket to the tooth-position pads. Preferably, however, the cover 15 will be sealed 19 to the bonding card so that the receptacles act as a container or housing over the orthodontic brackets so that the receptacles do not touch the orthodontic brackets, but merely protect them until the orthodontic brackets are ready for use. As clearly shown in FIG. 6, which is an exploded view of the cover 15 prior to being sealed onto a portion of the bonding card 11, the plastic cover is relatively thin and has receptacles 16 formed in a raised position in order to accommodate the orthodontic brackets. Once the orthodontic brackets are placed in the appropriate positions on the tooth-position pads 13, the cover 15 is placed onto the bonding card and sealed 19 with an adhesive or by other appropriate sealing means. The cover is designed to be easily removed from the bonding card by the orthodontist when it is time to place the orthodontic brackets on the patient's teeth. Thus, the sealant or adhesive used to seal the cover to the bonding card should be easily released by the orthodontist without disrupting the position of the orthodontic brackets with respect to their corresponding tooth-position pads. Elongated wells or troughs 17 are also formed in cover 15 to give the orthodontist the option to put a cement, a sealant or a primer in the wells to assist in mounting the orthodontic brackets on the patient's teeth. For example, any well known cement used in bonding orthodontic brackets to the patient's teeth can be place in elongated wells 17 so that the orthodontist may use a pair of tweezers to remove the orthodontic bracket 12 from a tooth position pad, dip a portion of the bracket in the cement, and then place the orthodontic bracket on the patient's tooth for bonding thereon. This “adhesive well” can also be accessed with a bonding spatula to transfer adhesive from the well to the mesh back of a bracket. Examples of commercially available cements are Ormco-System One Plus, Ormco Corporation; Transbond, 3M Unitek; and Reliance Rely a Bond, Reliance Co.

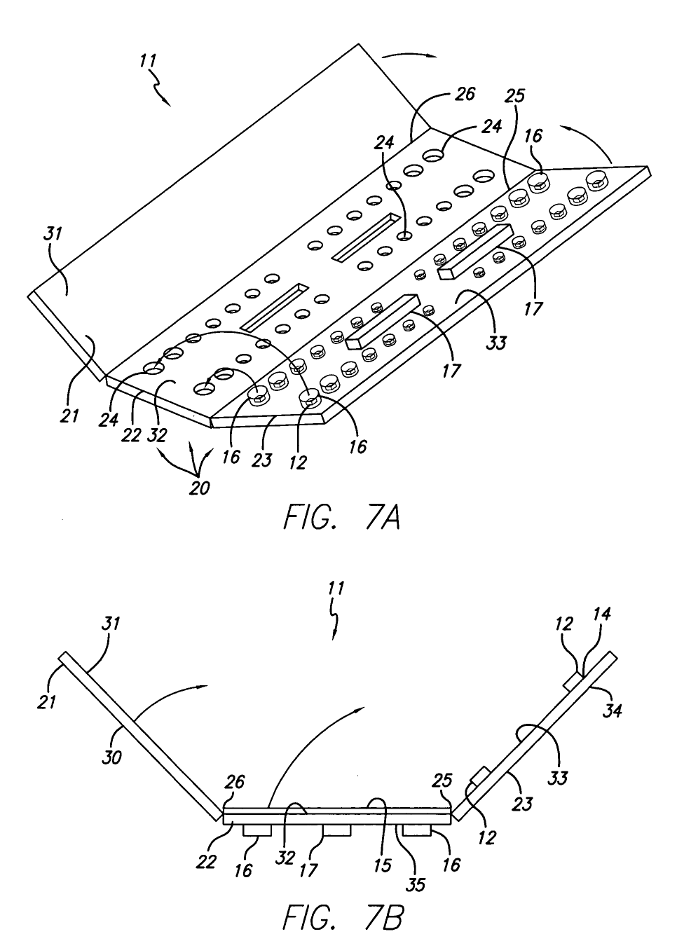

Referring to FIG. 7A, after the orthodontic brackets 12 are mounted on the tooth-position pads 13, and after cover 15 has been sealed to the bonding card 11, the bonding card is folded to provide a more convenient package for transport and storage. In keeping with the invention, in this embodiment, the bonding card is formed of elongated sections 20 that are folded together. First elongated section 21 is attached to second elongated section 22, and third elongated section 23 is attached to the second elongated section. The elongated sections are separated by fold lines 25,26 which allow the sections to be folded onto each other to provide a bonding card 11 that is a single elongated card for easy transport and storage. As shown in FIG. 7, second elongated section 22 includes openings 24 that correspond to the receptacles 16 on third elongated section 23. In order to fold the bonding card, the third elongated section is folded along fold line 25 in the direction of the arrows. The receptacle 16 correspond to respective openings 24 in the second elongated section so that as the third elongated section mates with the second elongated section, the receptacle 16 will protrude through the openings 24 and project out of the openings. Thereafter, the first elongated section is folded along fold line 26 in the direction of the arrows so that the first elongated section will mate with the third elongated section, the third elongated section essentially being sandwiched between the first and second elongated sections. A pressure sensitive adhesive (not shown) can be applied to any of the mating surfaces in order to assist in folding the elongated sections into a single-section bonding card. The pressure sensitive adhesive should be just sticky enough to hold the elongated sections in a mating relationship, but easily releasable for the orthodontist to open the bonding card for access to the orthodontic brackets.

In another embodiment, as shown in FIG. 7B, the cover 15, which contains the receptacles 16, is secured to the third face 32 of second section 22. As can be seen, the receptacles 16 and the elongated wells 17 project outwardly from the sixth face 35 on the second elongated section. The orthodontic brackets 12 have been positioned on the tooth position pads 13 and securely, but releasably fastened by pressure sensitive adhesive 14. In this embodiment, the cover 15 is folded onto the third elongated section 23 so that the orthodontic brackets 12 will correspond to the receptacles 16. After the third elongated section is folded at fold line 25, the orthodontic brackets will be housed and protected by the receptacles 16. Thereafter, the first elongated section 21 is folded at fold line 26 in the direction of the arrow so that second face 31 mates with fifth face 34 to provide a closed package that is a single elongated bonding card for easy transport and storage. Unfolding the bonding card 11 should be in reverse order of the folding sequence. Further, one or more surfaces of the bonding card can have a pressure sensitive adhesive so that when the bonding card is opened by the orthodontist for use, the bonding card can be releasably attached to a surface, such as a table or tray for easy access by the orthodontist. As previously discussed, the elongated wells 17 can be used to hold glue, an adhesive, a sealant, a primer, or any fluid required by the orthodontist to assist in mounting the orthodontic brackets on the patient's teeth.

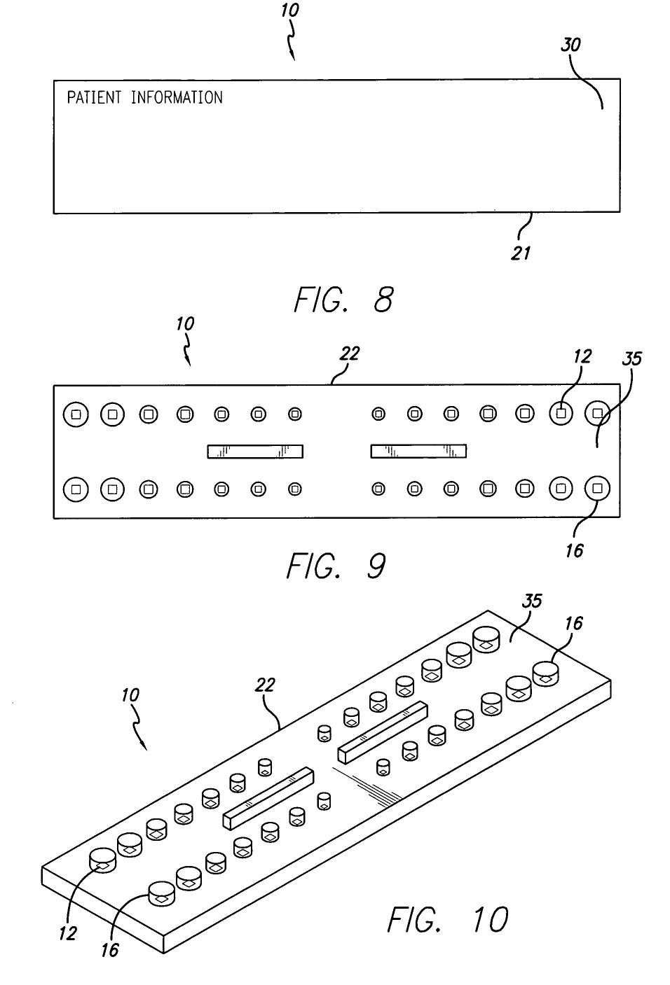

In further reference to the embodiments disclosed in FIGS. 1-10, bonding card 11 includes the elongated sections 20 previously described. More particularly, the first elongated section has a first face 30 and the opposite side of the bonding card has a second face 31. The second elongated section 22 has a third face 32 and the opposite side of the bonding card has a sixth face 35. The third elongated section 23 has a fourth face 33 and the opposite side of the bonding card has a fifth face 34. As shown in FIG. 8, after the bonding card has been folded, the first face 30 is exposed, and can be used to provide patient information which can include the patient's name, the orthodontic prescription and the name and address of the orthodontist's place of business. Likewise, after the bonding card has been folded, as shown in FIG. 9, the sixth face 35 is exposed. The sixth face provides the orthodontist the ability to view the brackets through the transparent receptacles 16 as shown in FIGS. 9 and 10. As shown in FIG. 10, for example, the receptacles project outwardly and preferably are transparent so that the orthodontic brackets 12 are visible.

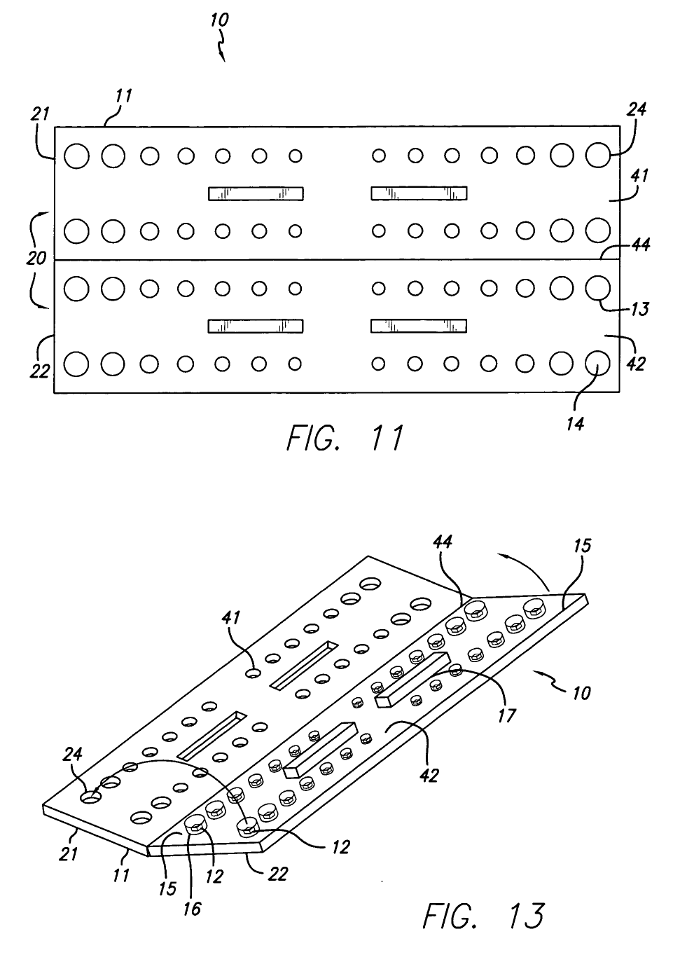

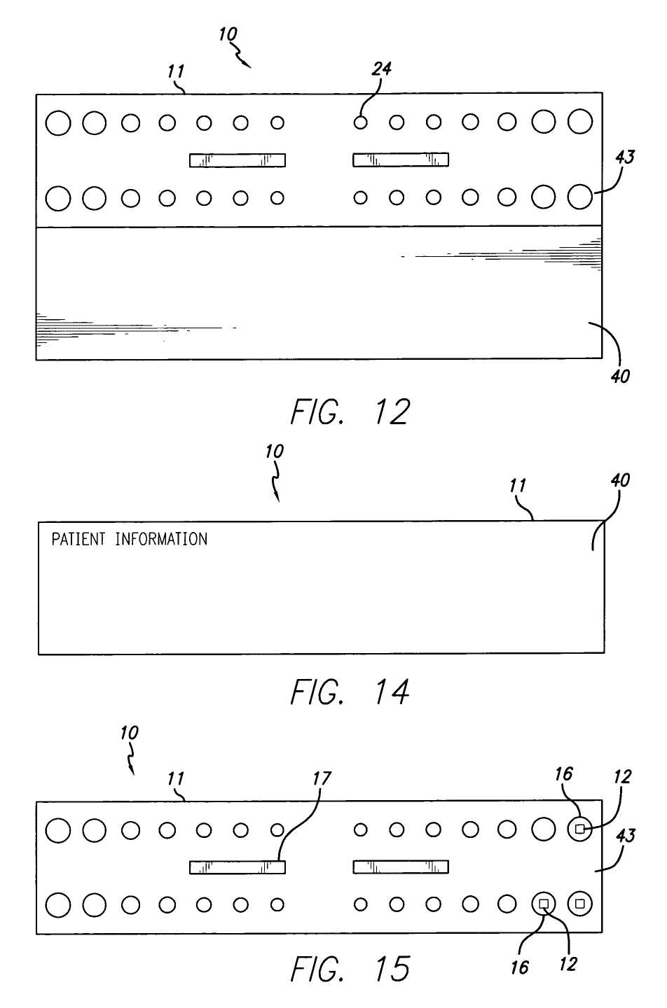

In another embodiment, as shown in FIGS. 11-13, a kit 10 is provided which includes a bonding card 11 designed to hold orthodontic brackets 12. In this embodiment, there are elongated sections 20, including a first elongated section 21 and a second elongated section 22. The bonding card also has tooth position pads 13 which have pressure sensitive adhesive 14 in order to hold the orthodontic brackets 12 in position on the tooth position pads. As with other embodiments, a cover 15 includes receptacles 16 and elongated wells 17. The main difference between the bonding card of this embodiment and that described above, is that in this embodiment there are only two elongated sections, while the previously described embodiment had three elongated sections. Referring to FIGS. 11-15, the first elongated section 21 has a second face 41 and a fourth face 43 on its opposite side. Likewise, second elongated section 22 has a first face 40 and on its opposite side third face 42. The orthodontic brackets are mounted on the third face 42 prior to folding the first and second sections together. As shown in FIG. 13, in one embodiment the cover 15 is releasably sealed over the orthodontic brackets 12 so that the cover is in sealing engagement with third face 42. The third face is folded at fold line 44 in the direction of the arrows so that the receptacles 16 and the elongated wells 17 extend through the openings in the first elongated section. When the bonding card is folded, the second face 41 and the third face 42 are in mating relationship, with the receptacles 16 protruding outwardly from fourth face 43, as shown in FIG. 15. When folded, the first face 40 can contain patient information as previously described. In an alternative embodiment, the cover 15 can be sealed to the second face 41 so that the orthodontic brackets will be received into the receptacles as the third face is folded into engagement with the cover and the second face 41.

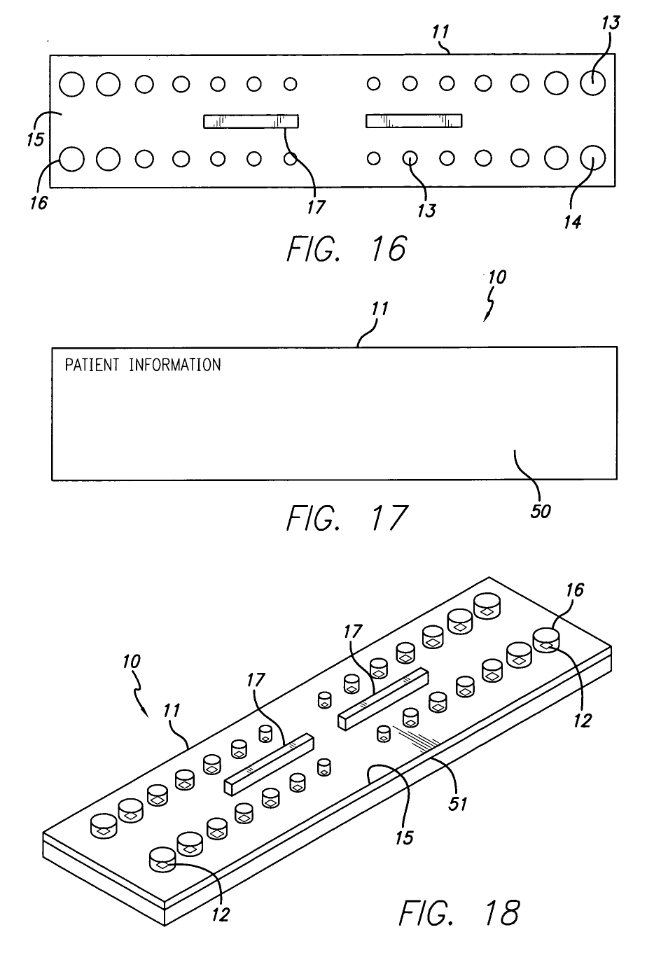

In another embodiment of the invention, shown in FIGS. 16-18, a single elongated section 20 forms the kit 10. The kit includes a bonding card 11 having tooth position pads 13 covered with pressure sensitive adhesive 14 in order to hold orthodontic brackets 12 in position. In this embodiment, the cover 15 sealingly engages with a second face 51, and on the opposite side of the bonding card is first face 50. The cover 15 includes receptacles 16 which house or contain the orthodontic brackets 12, and elongated well 17 for holding an adhesive, a sealant or a primer, as previously described. Since this embodiment discloses a single elongated section, it does not have to be folded in order to form kit 10. Once the orthodontic brackets 12 are placed on the tooth position pads 13, they will be releasably retained by the pressure sensitive adhesive 14. Thereafter, cover 15 can be sealingly mated to second face 51. Patient information, as previously described, can be placed on first face 50. When the orthodontist is ready to mount the orthodontic brackets on the patient's teeth, the cover 15 can be removed for easy access to the orthodontic brackets.

With respect to all of the embodiments of the bonding card 11 as disclosed herein, each can have means for releasably attaching the bonding card to a surface or workstation so that the orthodontist can more easily tweezer brackets off of the bonding card and have access to the adhesive in the elongated wells 17. Thus, for example, with respect to the bonding card shown in FIG. 7B, any of first base 30, third base 32, or fifth base 34 can have a transfer tape placed on the surface in the form of two strips that can be removed by the orthodontist. When the two strips are removed by the orthodontist, a sticky backing is revealed so that the face will releasably adhere to a workstation for tweezering the brackets or working with the bonding adhesive. One or more strips of the transfer tape can be applied to any of the disclosed surfaces of the bonding card so that the bonding card can be temporarily adhered to a workstation to assist the orthodontist in removing brackets from the bonding card and removing bonding adhesive from the wells 17.

Also in keeping with the invention, the bonding cards can be sealed with clear seal tapes having perforated sections that can be easily broken by the orthodontist when the bonding card is ready for use. The clear seal tapes can be placed transverse to the elongated portion of the bonding card with a perforated strip that can be easily removed so that the bonding card can be opened. Similarly, the clear seal tape can run lengthwise along the elongated portion of the bonding card, and again can be easily removed by pulling along a perforated section of the seal tape. The clear seal tape provides easy access to the bonding card and also protects the brackets from any contamination during transport from the orthodontic manufacturer to the orthodontist's office.

The disclosed embodiments depict the prescription kit 10 as having an elongated bonding card 11. The invention is broader in that the bonding card can be any convenient shape such as elongated, square, oval, or arch-shaped, and still perform according to the invention.

The method for providing orthodontic brackets to supply a single patient prescription requires that the orthodontist provide a prescription order to the orthodontic manufacturer. The prescription order can be communicated to the orthodontic manufacturer by any means, including by telephone, e-mail, website or by facsimile. It may be convenient for the orthodontic manufacturer to provide a specific order form to be filled out by the orthodontist so that uniform instructions are received for each order. Typically, the patient prescription order will be filled by the orthodontic manufacturer within twenty-four hours, however, the time for filling the prescription order can be several days depending on the needs of the orthodontist. Preferably, from the time the prescription order is received by the orthodontic manufacturer, until the time the orthodontic brackets are shipped or mailed to the orthodontist, is less than twenty-four hours.

After the orthodontic manufacturer receives the prescription order, the orthodontic brackets are selected from the orthodontic manufacturer's inventory of brackets and assembled on the prescription kit and bonding card as previously described. Thereafter, the patient information is placed on the prescription kit and the prescription kit is then sent to the orthodontist by any number of means, including hand delivery, by an express mail service, by UPS, or by regular mail. Alternatively, after the manufacturer places the orthodontic brackets in the prescription kit, the kit is sent to the orthodontist who then puts whatever patient information is desired on the kit. Once the orthodontist receives the prescription kit, it can be stored until the brackets are ready to be mounted on the patient's teeth. By providing brackets in this manner, the orthodontist does not have to carry a large inventory of orthodontic brackets to accommodate various patient prescriptions. The orthodontist will also have an option to order pre determined prescriptions determined by the manufacturer.

In one embodiment, predetermined patient prescription kits are to be assembled and stored by the orthodontic manufacturer. The orthodontist can order the kit by part number and will receive the preassembled kit with the predetermined patient prescription. The orthodontic brackets in these kits are selected by the manufacturer based on past histories of frequently used combinations of brackets having specific angulations. Further, these kits are especially convenient for the orthodontist who simply orders by a single part number and receives a standard set of brackets in the kit described herein.

While a particular form of the invention has be illustrated and described, it will also be apparent to those skilled in the art that various modifications can be made without departing from the spirit and scope of the invention. Accordingly, it is not intended that the invention be limited except by the appended claims.

What is claimed:

1. A method for providing orthodontic brackets to supply a single patient prescription, comprising:
receiving a prescription order for orthodontic brackets for a single patient;
processing the prescription order by selecting orthodontic brackets from an inventory of brackets;
organizing the selected orthodontic brackets in a prescription kit;
sending the prescription kit to an orthodontist.

2. The method of claim 1, wherein the selection of orthodontic brackets is from an inventory of brackets maintained by an orthodontic bracket manufacturer.

3. The method of claim 1, wherein the prescription kit is labeled to identify the orthodontic brackets to correspond to the prescription order.

4. The method of claim 1, wherein the prescription kit is sent to the orthodontist within one to three days of receipt of the prescription order.

5. The method of claim 1, wherein the prescription kit is sent to the orthodontist in less than twenty-four hours of receipt of the prescription order.

6. The method of claim 1, wherein the selected orthodontic brackets are individually, releaseably mounted on a bonding card.

7. The method of claim 6, wherein the bonding card includes a pressure sensitive adhesive for releaseably retaining each selected orthodontic bracket for storage and shipping.

8. The method of claim 7, wherein the adhesive is biocompatible.

9. The method of claim 7, wherein the adhesive is acrylic based.

10. The method of claim 7, wherein the adhesive has a thickness in the range of about 0.50 mils to about 1.5 mils.

11. The method of claim 10, wherein the orthodontic brackets can be repeatedly mounted and removed from the bonding card.

12. The method of claim 1, wherein the orthodontic brackets are sealed and protected in order to maintain the position of each bracket.

13. The method of claim 1, wherein the prescription order is an order form provided by the orthodontic manufacturer for an orthodontist.

14. A kit for providing orthodontic brackets for an individual patient according to a prescription order, comprising:
a bonding card having multiple tooth-position pads;
a pressure sensitive adhesive associated with the tooth-position pads to releaseably secure an orthodontic bracket to each tooth-position pad;
a cover positioned over the orthodontic brackets to maintain the position of the brackets on the bonding card; and
labeling information associated with the bonding card for patient identification.

15. The kit of claim 14, wherein the cover is transparent.

16. The kit of claim 14, wherein the cover is light sensitive so that the pressure sensitive adhesive does not polymerize.

17. The kit of claim 14, wherein the adhesive is biocompatible.

18. The kit of claim 14, wherein the adhesive is acrylic based.

19. The kit of claim 14, wherein the adhesive has a thickness in the range of about 0.50 mils to about 1.5 mils.

20. The kit of claim 15, wherein the cover is sealed to the bonding card.

21. The kit of claim 20, wherein the cover is formed of a transparent polymer and has multiple receptacles located at each tooth-position pad.

22. The kit of claim 14, wherein the bonding card has three elongated sections separated by fold lines.

23. The kit of claim 22, wherein the bonding card includes a first face, second face, third face, fourth face, fifth face, and sixth face.

24. The kit of claim 23, wherein the bonding card is folded along the fold lines so that the third face and fourth face mate, and the second face and the fifth face mate.

25. The kit of claim 24, wherein a pressure sensitive adhesive is on the fifth face so that the second face releaseably adheres to the fifth face.

26. The kit of claim 23, wherein the third face has openings that correspond to the receptacles located on the fourth face.

27. The kit of claim 26, wherein the receptacles on the fourth face project through the openings on the third face so that the orthodontic brackets are visible on the sixth face.

28. The kit of claim 14, wherein the cover includes a well for receiving fluid.

29. The kit of claim 28, wherein the well is configured to receive an adhesive, sealant or primer.

30. The kit of claim 14, wherein a releasable adhesive is associated with a portion of the bonding card to secure the bonding card to a surface while removing the orthodontic brackets from the tooth position pads.
